(19) United States
(12) Patent Application Publication
(10) Pub. No.: US 2015/0178278 A1
(43) Pub. Date: Jun. 25, 2015

(54) IDENTIFYING RECENTLY SUBMITTED QUERY VARIANTS FOR USE AS QUERY SUGGESTIONS

(71) Applicants: Lev Finkelstein, Netanya (IL); Alon Mittelman, Tel Aviv (IL); Ari Shotland, Haifa (IL); Yaniv Carmeli, Akko (IL)

(72) Inventors: Lev Finkelstein, Netanya (IL); Alon Mittelman, Tel Aviv (IL); Ari Shotland, Haifa (IL); Yaniv Carmeli, Akko (IL)

(73) Assignee: GOOGLE INC., Mountain View, CA (US)

(21) Appl. No.: 13/419,296

(22) Filed: Mar. 13, 2012

(51) Int. Cl. G06F 17/30

(52) U.S. Cl. CPC G06F 17/3053

(57) ABSTRACT

Methods, systems, and apparatus are described that include processing queries submitted by a plurality of users. A plurality of fresh queries is identified, where a fresh query is a query that has been submitted during a current time interval. The identified fresh queries are then reformulated into corresponding canonical representations using canonicalization rules. A group of fresh queries in the plurality of fresh queries having matching canonical representations are then selected. A group popularity score is then calculated for the group based at least in part on a number of times that one or more of the fresh queries in the group have been submitted during the current time interval. In response to a determination that the group popularity score satisfies a threshold popularity score, data is then stored identifying the fresh queries in the group of fresh queries as being permitted for use in determining a query suggestion.

### BACKGROUND

The present disclosure relates to identifying search query suggestions.

Information retrieval systems, such as Internet search engines, help users by retrieving information, such as web pages, images, text documents and multimedia content, in response to queries. Search engines use a variety of signals to determine the relevance of the retrieved content to the user's query.

Formulating a query that accurately represents the user's informational need can be challenging. Search engines may suggest queries to the user, to help the user. Some search engines provide query suggestions to the user as the user is typing a query.

The queries suggested by the search engine often are taken from past user queries. For various reasons it can be difficult to evaluate the usefulness of a past query as a query suggestion. In particular, due to the sparse nature of infrequently submitted queries, it can be difficult to identify recently submitted infrequent queries that are likely to assist users in finding the information they seek.

The search engine may thus limit the query suggestions to those that are popular, such as those that have been submitted more than a particular number of times, and/or submitted by more than a certain number of users. However, as new queries are continually submitted which represent new information requests, the information coverage represented by the past popular queries can quickly become stale and out-of-date.

### SUMMARY

In one implementation, a method of processing queries submitted by a plurality of users is described. The method includes identifying a plurality of fresh queries. A fresh query is a query that has been submitted during a current time interval. The identified fresh queries are then reformulated into corresponding canonical representations using canonicalization rules. A group of fresh queries in the plurality of fresh queries are then selected. The fresh queries in the group have matching canonical representations. A group popularity score is then calculated for the group of queries. The group popularity score is based at least in part on a number of times that one or more of the fresh queries in the group have been submitted during the current time interval. The method also includes determining that the group popularity score for the group satisfies a threshold popularity score. In response to the determination, data is then stored identifying the fresh queries in the group of fresh queries as being permitted for use in determining a query suggestion.

This method and other implementations of the technology disclosed can each optionally include one or more of the following features.

The current time interval can be an interval of time since fresh queries have most recently been identified.

The current time interval can be a predetermined interval of time.

The method can further include calculating individual popularity scores for the fresh queries in the group. An individual popularity score for a given fresh query can be based at least in part on a number of times the given fresh query has been submitted during the current time interval. The individual popularity scores for the fresh queries in the group can then be used to calculate the group popularity score of the group.

Using the individual popularity scores can include summing the individual popularity scores to calculate the group popularity score for the group.

Using the individual popularity score can include using the individual popularity scores for a predetermined number of fresh queries having the highest individual popularity scores to calculate the group popularity score for the group. The predetermined number can be one.

The fresh queries in the group can have identical canonical representations.

The canonicalization rules can include stemming of terms in the identified fresh queries.

The canonicalization rules can include arranging canonical forms of terms in the identified queries based on a predefined order.

The method can further include receiving a query. One or more of the permitted fresh queries can then be selected as query suggestions for the received query. The selected one or more permitted fresh queries can then be sent in response to receiving the query.

Other implementations may include a non-transitory computer readable storage medium storing instructions executable by a processor to perform a method as described above. Yet another implementation may include a system including memory and one or more processors operable to execute instructions, stored in the memory, to perform a method as described above.

Particular implementations of the subject matter described herein can identify recently submitted or fresh queries that are suitable for use as query suggestions. These fresh queries allow up-to-date query suggestions to be provided, which increases the likelihood of providing query suggestions that will assist users in finding the information they seek. In doing so, meaningful query suggestions can be provided to users seeking relatively new information that is outside the coverage of popular queries.

Particular aspects of one or more implementations of the subject matter described in this specification are group forth in the drawings and the description below. Other features, aspects, and advantages of the subject matter will become apparent from the description, the drawings, and the claims.

### BRIEF DESCRIPTION OF THE DRAWINGS

FIG. 1 illustrates a block diagram of an example environment in which selecting fresh queries suitable for use as query suggestions can be used.

FIG. 2 is a block diagram illustrating example modules within the fresh query engine.

FIG. 3 is a flow chart illustrating an example process for selecting fresh queries suitable for use as query suggestions.

FIG. 4 illustrates an example of fresh queries and their corresponding canonical representations.

FIG. 5 is a flow chart illustrating an example process for providing a permitted fresh query as a query suggestion.

FIG. 6 is a screenshot illustrating an example environment that can be used to provide fresh queries as query suggestions to a user.

FIG. 7 is a block diagram of an example computer system.

### DETAILED DESCRIPTION

Technology is described herein for identifying recently submitted queries for use as query suggestions that are likely to assist users in finding the information they seek. Recently submitted or fresh queries are periodically analyzed to identify groups of fresh queries that may represent relatively new requests for information. For example, fresh queries may be directed to breaking news or content that is in the process of going viral.

The fresh queries that are assigned to a given group are determined by comparing canonical representations of the fresh queries to one another. The canonical representations are generated using a set of canonicalization rules that enable matching of fresh queries that have different formulations, but which represent the same or similar information request. The use of the canonicalization rules enables the identification of a group of fresh queries that collectively represent the same or similar recently popular information request, but which individually may not be popular enough to reliably identify.

These fresh queries allow up-to-date query suggestions to be provided, which increases the likelihood of providing query suggestions that will assist users in finding the information they seek. In doing so, meaningful query suggestions can be provided to users seeking relatively new information that is outside the coverage of popular past queries.

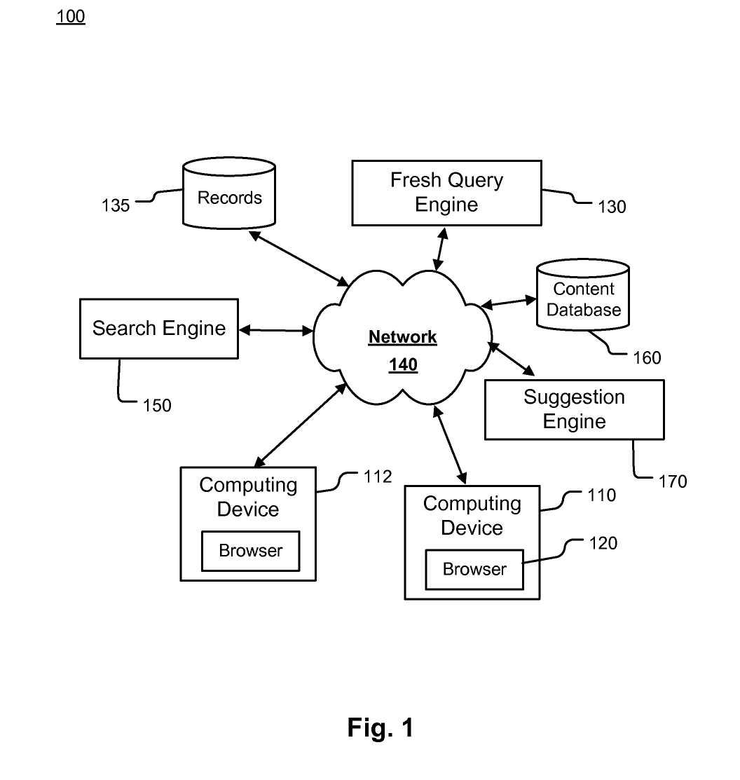

FIG. 1 illustrates a block diagram of an example environment 100 in which selecting fresh queries suitable for use as query suggestions can be used. The environment 100 includes client computing devices 110, 112 and a search engine 150. The environment also includes a communication network 140 that allows for communication between various components of the environment 100.

During operation, users interact with the search engine 150 through the client computing devices 110, 112. The client computing devices 110, 112 and the search engine 150 each include memory for storage of data and software applications, a processor for accessing data and executing applications, and components that facilitate communication over the communication network 140. The computing devices 110, 112 execute applications, such as web browsers (e.g. web browser 120 executing on computing device 110), that allow users to formulate queries and submit them to the search engine 150. The search engine 150 receives queries from the computing devices 110, 112, and executes the queries against a content database 160 of available resources such as web pages, images, text documents and multimedia content. The search engine 150 identifies content which matches the queries, and responds by generating search results which are transmitted to the computing devices 110, 112 in a form that can be presented to the users. For example, in response to a query from the computing device 110, the search engine 150 may transmit a search results web page to be displayed in the web browser 120 executing on the computing device 110.

The search engine 150 maintains records 135 of queries submitted by users. During operation, the search engine 150 is continually receiving new queries from users, and storing these new queries in the records 135. The search engine 150 may maintain an aggregated or anonymized record of queries. The records 135 may collectively be stored on one or more computers and/or storage devices.

The environment 100 also includes a fresh query engine 130. The records 135 are periodically processed by the fresh query engine 130 to select fresh queries that are suitable for use as query suggestions using the techniques described herein.

The term “periodically” is used herein to indicate that the analysis is performed from time-to-time or occasionally. The term “periodically” is not intended to imply or require that the analysis be performed at fixed intervals of time.

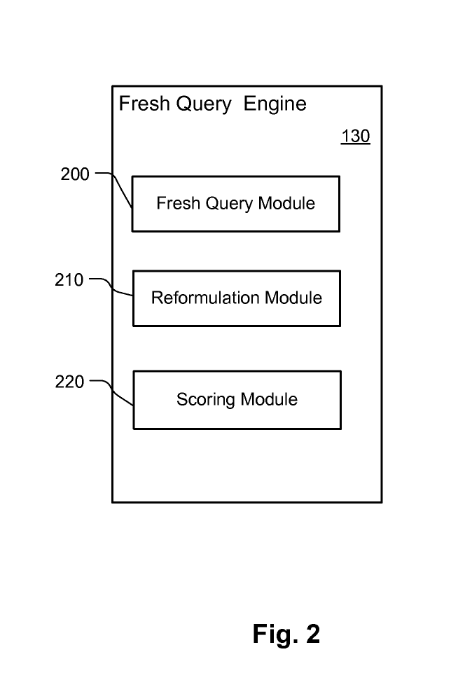

The fresh query engine 130 can be implemented in hardware, firmware, or software running on hardware. The fresh query engine 130 is described in more detail below with reference to FIGS. 2-6.

In response to a user's query, an application executing on the user's client computing device may forward the user's query to a suggestion engine 170. The user's query may be a partial query or a complete query. The suggestion engine 170 includes memory for storage of data and software applications, a processor for accessing data and executing applications, and components that facilitate communication over the communication network 140. The suggestion engine 170 may use conventional or other techniques to select one or more of the selected fresh queries as query suggestions for the user's query. The suggestion engine 170 can then provide these query suggestions to the user. Alternatively, the suggestion engine 170 may provide these query suggestions to the search engine 150, which in turn provides them to the user.

These query suggestions provided by the suggestion engine 170 represent queries that the users may want to submit in addition to, or instead of, the query actually typed or submitted. The query suggestions may, for example, be embedded within a search results web page to be displayed in an application, such as a web browser, executing on the user's computing device. As another example, the query suggestions may be displayed within a cascaded drop down menu of the search field of an application, such as a web browser, executing on the user's computing device as the user is typing the query. In some implementations, search results for a query suggestion within the cascaded drop down menu are also displayed as the user is typing the query.

The network 140 facilitates communication between the various components in the environment 100. In one implementation, the network 140 includes the Internet. The network 140 can also utilize dedicated or private communication links that are not necessarily part of the Internet. In one implementation, the network 140 uses standard communications technologies, protocols, and/or inter-process communication techniques.

FIG. 2 is a block diagram illustrating example modules within the fresh query engine 130. In FIG. 2, the fresh query engine 130 includes a fresh query module 200, a reformulation module 210 and a scoring module 220. Some implementations may have different and/or additional modules than those shown in FIG. 2. Moreover, the functionalities can be distributed among the modules in a different manner than described herein.

The fresh query module 200 periodically analyzes the records 135 to identify fresh queries that have been submitted by users during a current time interval. The fresh query module 200 also counts the number of times each of the fresh queries that have been submitted by users during the current time interval.

In some implementations, these fresh past queries include one or more fresh infrequent queries. A fresh infrequent query in the records 135 is a query that has been submitted less than a threshold number of times during the current time interval. A variety of different techniques can be used to determine the threshold number. For example, the threshold number may be a manually selected constant. As another example, the threshold number may be determined based on statistical information such as the confidence level. In other words, the fresh queries are filtered by selecting those having confidence levels that satisfy a predetermined confidence threshold. As yet another example, the threshold number may be determined based on resource constraints such as a limited memory. In some implementations, the amount of available memory is used to limit the maximum number of fresh queries that will be selected.

The term “current time interval” refers to at least a portion of the most recent interval of time during which queries have been collected in the records, but not yet analyzed to identify fresh queries suitable for use as query suggestions. In some implementations, the current time interval is the entire interval of time since fresh queries in the records have most recently been identified. The current time interval can be a relatively short interval of time (e.g. 24 or 48 hours or less) over which it may be difficult to identify queries that may be useful query suggestions based strictly on their individual popularity.

The current time interval may for example end at the time when the analysis begins. Alternatively, the current time interval may end a given time, before the analysis begins.

The current time interval may for example be a fixed predetermined interval of time. Alternatively, the current time interval may be variable in length.

The reformulation module 210 reformulates the fresh queries into respective canonical representations using a set of canonicalization rules. The canonicalization rules enable matching of fresh queries that have different formulations, but which represent the same or similar user information request. The canonicalization rules can vary from implementation to implementation.

Canonicalization can include the process of converting the terms in a query into a standard form by replacing the terms with their canonical forms when the terms meet certain criteria. With canonicalization, fresh queries that represent the same or similar information request can be matched, so that queries that can be meaningful query suggestions can be identified.

In some implementations, the canonicalization rules include stemming of terms in the queries. Stemming is the process of reducing various grammatical forms of a term to a common root form. Stemming can include the removal and/or replacement of characters in the term. For example, stemming can include replacing plural nouns with corresponding singular nouns.

In some implementations, the canonicalization rules include the removal of terms in the identified fresh queries which are stop words. Stop words include words that are common. The stop words can include articles such as “a,” “and,” and “the.” The stop words can include conjunctions such as “or,” “and,” and “nor.” The stop words can also include prepositions such as “of” and “to.”

In some implementations, the canonicalization rules include arranging canonical forms of terms in the queries based on a predefined order. For example, the canonical forms of terms in the queries may be arranged in alphabetical order. Identical terms in a given query may also be removed in some implementations. The canonicalization rules may also include punctuation removal, lowercasing, removal of diacriticals, and URL normalization. Other canonicalization rules can also be used.

The scoring module 220 then compares the canonical representations of the fresh queries to one another to identify groups of fresh queries. The fresh queries in a group have matching canonical representations. The scoring module 220 may identify the fresh queries in a given group using a join type operation between the canonical representations.

In some implementations, the matching is carried out by exact matching of the canonical representation strings. In other implementations, this matching can be carried out by comparing the strings using soft matching. The soft matching may for example be carried out by calculating an edit distance between the strings and comparing that to a threshold.

The scoring module 220 also rejects fresh queries which have canonical representations which do not match that of at least another fresh query.

The scoring module 220 then calculates a group popularity score for each group of fresh queries. The group popularity score for a given group is based at least in part on a number of times that one or more of the fresh queries in the given group have been submitted during the current time interval. The group popularity score thus indicates the collective, recent popularity of the same or similar information request which is represented by the fresh queries in a group.

The techniques for calculating the group popularity score can vary from implementation to implementation.

In some implementations, the scoring module 220 calculates individual popularity scores for each fresh query in the given group. The individual popularity score of a particular fresh query may be calculated based on the number of times the particular fresh query has been submitted during the current time interval. The scoring module 220 can then calculate the group popularity score for the given group as a function of the individual popularity scores for fresh queries in the given group. This function may be for example a sum, a sum of log values of the individual popularity scores, or other function.

In some implementations, the scoring module 220 uses the individual popularity scores for all of the fresh queries in the given group to calculate the group popularity score. In other implementations, the scoring module 220 selects a predetermined number of the fresh queries in the group having the highest individual popularity scores. The individual popularity scores for the selected fresh queries can then be used to calculate the group popularity score. The predetermined number of the highest ranked fresh queries may for example be one or two. In one implementation, the scoring module 220 selects the fresh queries in the given group by sorting the fresh queries to create a ranking, and selects a predetermined number of the highest ranked fresh queries in the group.

Alternatively, other techniques may be used to calculate the group popularity score.

The scoring module 220 then compares the group popularity scores to a threshold popularity score. A variety of different techniques can be used to determine the threshold popularity score. For example, the threshold popularity score may be manually selected. As another example, the threshold popularity score may be based on statistical information, such as the confidence level of the group of fresh queries.

The use of the threshold popularity score allows for the identification of a group of fresh queries which collectively represent the same or similar recently popular information request, but which individually may not be popular enough to reliably identify.

Upon determining that the group popularity score of a given group satisfies the threshold popularity score, the scoring module 220 stores data identifying the fresh queries in the group as being permitted for use in determining a query suggestion. This data may, for example, be stored in the form of a query list or another type of data structure maintained by the scoring module 220. This data can then be used by the suggestion engine 170 to provide meaningful, up-to-date query suggestions to users.

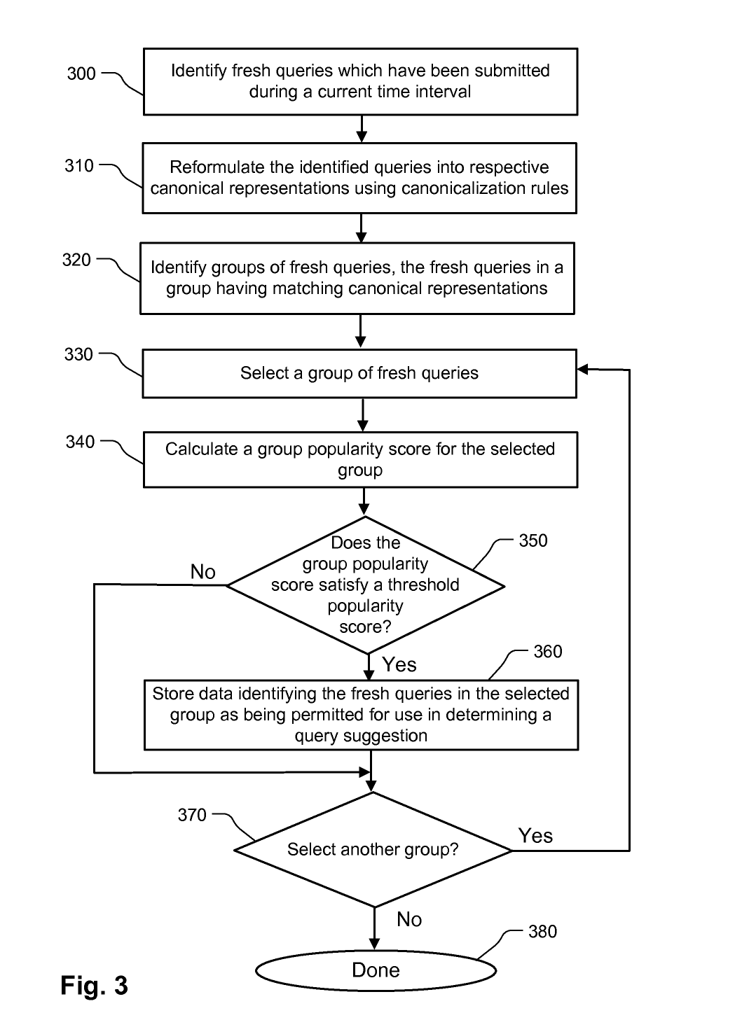

FIG. 3 is a flow chart illustrating an example process for selecting fresh queries for use as query suggestions. Other embodiments may perform the steps in different orders and/or perform different or additional steps than the ones illustrated in FIG. 3. For convenience, FIG. 3 will be described with reference to a system of one or more computers that performs the process. The system can be, for example, the fresh query engine 130 described above with reference to FIG. 1.

At step 300, the system identifies fresh queries in the records 135 which have been submitted during a current interval.

At step 310, the system formulates the identified fresh queries into respective canonical representations using canonicalization rules. At step 320, the system identifies groups of fresh queries. The fresh queries in a group have matching canonical representations.

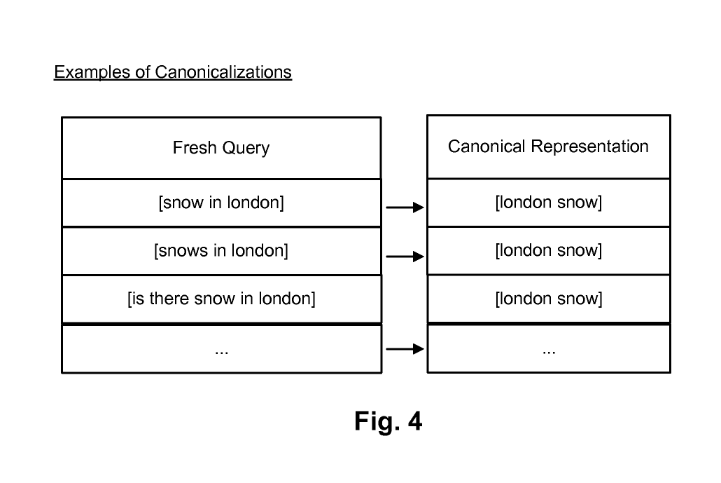

FIG. 4 illustrates an example of fresh queries and their canonical representations. In this example, the canonicalization rules include the removal of stop words, stemming and alphabetical reordering of the canonical forms of the remaining terms. As shown in FIG. 4, the fresh queries “snow in london”, “snows in london”, and “is there snow in london” have the same canonical representation, “london snow”. In such a case, these fresh queries would be included in the same group.

Returning to FIG. 3, at step 330 the system selects a group of fresh queries. At step 340, the system calculates a group popularity score for the selected group

At step 350, the system then compares the group popularity score for the selected group to a threshold popularity score. If the group popularity score for the selected group satisfies the threshold popularity score, the process continues to step 360. At step 360 the system stores data identifying the fresh queries in the selected group as being permitted for use in determining a query suggestion. If, at step 350, the group popularity score for the selected group does not satisfy the threshold popularity score, the process skips step 360.

At step 370, the system determines whether there are additional groups that need to be scored. If so, the process returns to step 330, where another group of fresh queries is scored. Once all the groups have been scored, the process ends at step 380.

The system can periodically repeat the process of FIG. 3, so that fresh queries suitable for use as query suggestions can continually be identified as new queries are submitted by users.

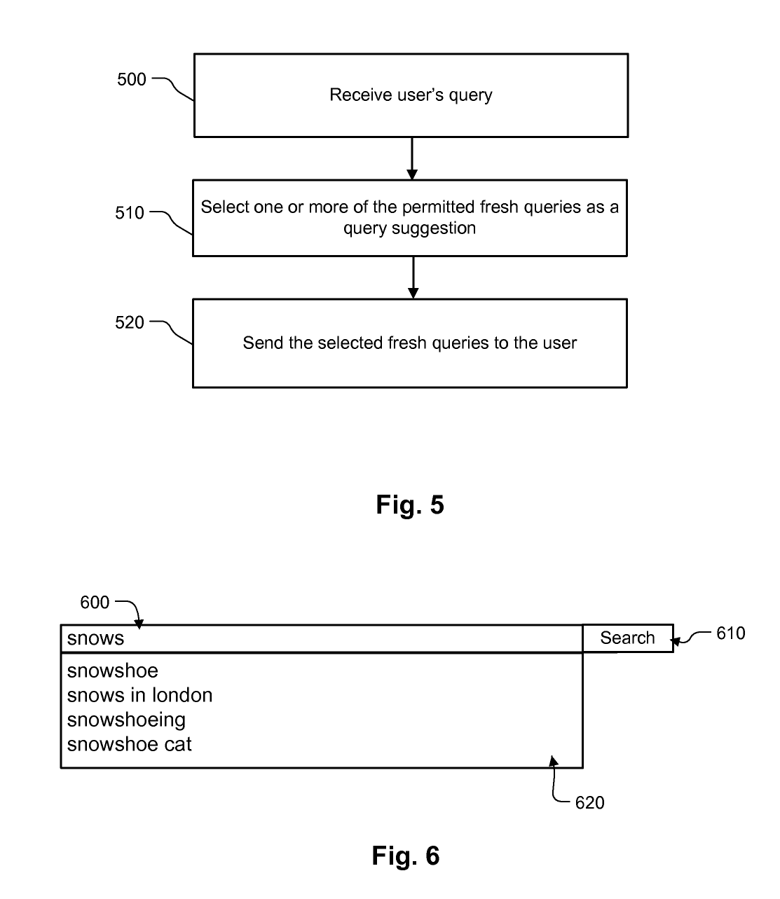

FIG. 5 is a flow chart illustrating an example process for providing a permitted fresh query as a query suggestion. Other embodiments may perform the steps in different orders and/or perform different or additional steps than the ones illustrated in FIG. 5. For convenience, FIG. 5 will be described with reference to a system of one or more computers that performs the process. The system can be, for example, the suggestion engine 170 described above with reference to FIG. 1.

At step 500, the system receives a user's query. The user's query may be a partial query or a complete query. A “partial query” is a query formulated by a user prior to an indication by the user that the query is complete. A user may indicate completion of the query by entering a carriage return or equivalent character. As another example, the user may indicate completion of the query by selecting a search button in a user interface presented to the user during entry of the query. As yet another example, the user may indicate completion of the query by saying a command in a speech interface or pausing more than a predetermined period of time.

At step 510, the system selects one or more of the permitted fresh queries as a query suggestion for the user's query. This selection can be performed by inspecting the query list or other data structure identifying the permitted fresh queries. The system may then match the user's query to one or more of the permitted fresh queries to select query suggestions for the user's query. The system may use conventional or other techniques to determine one or more of the permitted queries that are appropriate query suggestions for the user's query. For example, the system may use prefix based matching.

At step 520, the system sends the selected fresh queries as query suggestions to the user.

In some implementations, the system adds the selected fresh queries to a list of additional query suggestions for the user's query, and sends that list for display to the user. These additional query suggestions may for example be popular past queries that have been submitted by prior users at least a second threshold number of times. The popular past queries may be identified by analyzing the search queries submitted to the records 135 over a time interval greater than the current time interval used to identify the fresh queries. For example, the current time interval used to identify fresh queries may be for example 1 or 2 days, while the time interval used to identify popular past queries may be 60 days or more. The system may use conventional or other techniques to determine which of the popular past queries to select as additional query completions for the user's query.

The techniques for adding the selected fresh queries for the user's query to the list of additional query suggestions for the user's query can vary from implementation to implementation. In some implementations, the selected fresh queries may be inserted between the additional query suggestions in the list. In such a case, one or more of the selected fresh queries may be inserted based on their individual popularity scores (discussed above), and suggestion scores of the additional query suggestions.

A suggestion score represents an extent to which a given query suggestion is suitable for the user's query. The system may calculate suggestion scores based on the popularity of the query suggestions as search queries by past users. The popularity may be determined based on the frequency with which past users submitted the given query completion as a search query.

In some implementations, the individual popularity scores of the selected fresh queries may be modified to account for the time difference between the current time interval used to identify fresh queries, and the time interval used to identify popular past queries. For example, in implementations in which the popularity score is based on frequency of submission, the individual popularity score for a given fresh query can be multiplied by a ratio of the time interval used to identify popular past queries, to the current time interval used to identify the fresh query. In such a case, the modified popularity score of the given fresh query can compensate for the relatively short current time interval during which it has submitted, as compared to the longer time interval during which popular past queries have been submitted. In doing so, the range of values of the modified popularity scores of the fresh queries can be similar to that of the popular past queries, so that the popularity scores of the fresh queries and the popular past queries can be directly compared to one another for use in selecting query suggestions for a user's query.

A given fresh query having a modified individual popularity score that is between the suggestion scores of a pair of query suggestions in the list may then be added between the two query suggestions in the pair.

In some implementations, the selected fresh queries may be arranged at the beginning or end of the list, before or after the additional query suggestions. Alternatively, other techniques may be used.

FIG. 6 is a partial screen shot illustrating an example environment that can be used to provide fresh queries as meaningful, up-to-date query suggestions to a user. In FIG. 6, the partial screen shot includes a search field representation 600 and a search button representation 610. In this example, while the user is entering the partial query “snows” into the search field representation 600, a cascaded drop down menu 620 of the search field is displayed. In this example, the drop down menu 620 includes the fresh query “snows in london” as a query suggestion, along with the additional query suggestions “snowshoe”, “snowshoeing” and “snowshoe cat”.

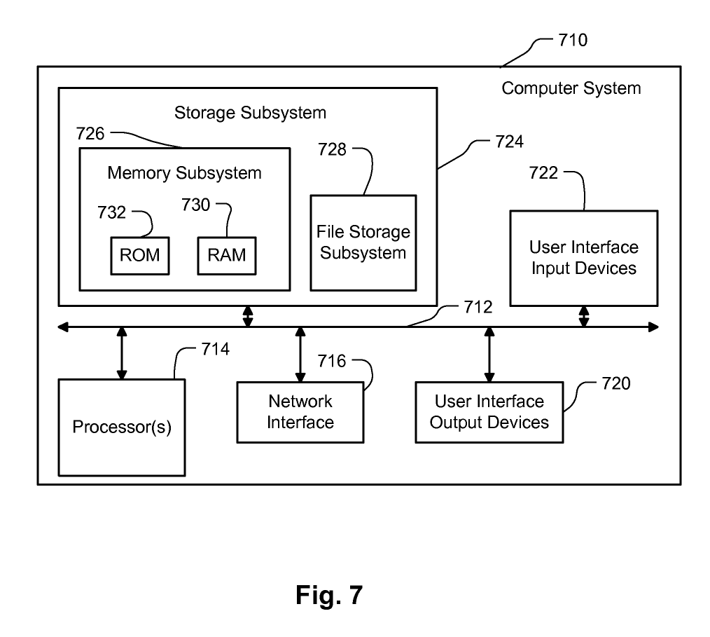

FIG. 7 is a block diagram of an example computer system. Computer system 710 typically includes at least one processor 714 which communicates with a number of peripheral devices via bus subsystem 712. These peripheral devices may include a storage subsystem 724, comprising for example memory devices and a file storage subsystem, user interface input devices 722, user interface output devices 720, and a network interface subsystem 716. The input and output devices allow user interaction with computer system 710. Network interface subsystem 716 provides an interface to outside networks, including an interface to communication network 140, and is coupled via communication network 140 to corresponding interface devices in other computer systems.

User interface input devices 722 may include a keyboard, pointing devices such as a mouse, trackball, touchpad, or graphics tablet, a scanner, a touchscreen incorporated into the display, audio input devices such as voice recognition systems, microphones, and other types of input devices. In general, use of the term “input device” is intended to include all possible types of devices and ways to input information into computer system 710 or onto communication network 140.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 710 to the user or to another machine or computer system.

Storage subsystem 724 stores programming and data constructs that provide the functionality of some or all of the modules described herein, including the logic to select fresh queries for use as query suggestions according to the processes described herein. These software modules are generally executed by processor 714 alone or in combination with other processors.

Memory 726 used in the storage subsystem can include a number of memories including a main random access memory (RAM) 730 for storage of instructions and data during program execution and a read only memory (ROM) 732 in which fixed instructions are stored. A file storage subsystem 728 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 728 in the storage subsystem 724, or in other machines accessible by the processor.

Bus subsystem 712 provides a mechanism for letting the various components and subsystems of computer system 710 communicate with each other as intended. Although bus subsystem 712 is shown schematically as a single bus, alternative embodiments of the bus subsystem may use multiple busses.

Computer system 710 can be of varying types including a workstation, server, computing cluster, blade server, server farm, or any other data processing system or computing device. Due to the ever-changing nature of computers and networks, the description of computer system 710 depicted in FIG. 7 is intended only as a specific example for purposes of illustrating the preferred embodiments. Many other configurations of computer system 710 are possible having more or fewer components than the computer system depicted in FIG. 7.

While the present invention is disclosed by reference to the preferred embodiments and examples detailed above, it is understood that these examples are intended in an illustrative rather than in a limiting sense. Computer-assisted processing is implicated in the described embodiments. Accordingly, the present invention may be embodied in methods for selecting fresh queries for use as query suggestions, systems including logic and resources to select fresh queries for use as query suggestions, systems that take advantage of computer-assisted methods for selecting fresh queries for use as query suggestions, media impressed with logic to select fresh queries for use as query suggestions, data streams impressed with logic to select fresh queries for use as query suggestions, or computer-accessible services that carry out computer-assisted methods for selecting fresh queries for use as query suggestions. It is contemplated that modifications and combinations will readily occur to those skilled in the art, which modifications and combinations will be within the scope of the following claims.

We claim as follows:

1. A method of processing queries submitted by a plurality of users, the method comprising:
identifying a plurality of fresh queries, wherein a fresh query is a query that has been submitted during a current time interval;
reformulating the identified fresh queries into corresponding canonical representations using canonicalization rules;
selecting a group of fresh queries in the plurality of fresh queries, wherein the fresh queries in the group of fresh queries are selected for inclusion in the group of fresh queries based on determining the fresh queries in the group of fresh queries have matching canonical representations;
calculating a group popularity score for the group of fresh queries, wherein the group popularity score is based at least in part on a number of times that one or more of the fresh queries in the group have been submitted during the current time interval;
determining that the group popularity score for the group satisfies a threshold popularity score; and
in response to the determination, storing data identifying the fresh queries in the group of fresh queries as being permitted for use in determining a query suggestion.

2. The method of claim 1, wherein the current time interval is an interval of time since fresh queries have most recently been identified.

3. The method of claim 1, wherein the current time interval is a predetermined interval of time.

4. The method of claim 1, further comprising:
calculating individual popularity scores for the fresh queries in the group, wherein an individual popularity score for a given fresh query is based at least in part on a number of times the given fresh query has been submitted during the current time interval; and
using the individual popularity scores for the fresh queries in the group to calculate the group popularity score of the group.

5. The method of claim 4, wherein using the individual popularity scores comprises summing the individual popularity scores to calculate the group popularity score for the group.

6. The method of claim 4, wherein using the individual popularity score comprises using the individual popularity scores for a predetermined number of fresh queries having the highest individual popularity scores to calculate the group popularity score for the group.

7. The method of claim 6, wherein the predetermined number is one.

8. The method of claim 1, wherein the fresh queries in the group have identical canonical representations.

9. The method of claim 1, wherein the canonicalization rules include stemming of terms in the identified fresh queries.

10. The method of claim 1, wherein the canonicalization rules include arranging canonical forms of terms in the identified fresh queries based on a predefined order.

11. The method of claim 1, further comprising:
receiving a query;
selecting one or more of the permitted fresh queries as query suggestions for the received query; and
sending the selected one or more permitted fresh queries in response to receiving the query.

12. A system including memory and one or more processors operable to execute instructions, stored in the memory, to process queries submitted by a plurality of users, comprising instructions to:
identify a plurality of fresh queries, wherein a fresh query is a query that has been submitted during a current time interval;
reformulate the identified fresh queries into corresponding canonical representations using canonicalization rules;
select a group of fresh queries in the plurality of fresh queries, wherein the fresh queries in the group of fresh queries are selected for inclusion in the group of fresh queries based on determining the fresh queries in the group of fresh queries have matching canonical representations;
calculate a group popularity score for the group of fresh queries, wherein the group popularity score is based at least in part on a number of times that one or more of the fresh queries in the group have been submitted during the current time interval;
determine that the group popularity score for the group satisfies a threshold popularity score; and
in response to the determination, store data identifying the fresh queries in the group of fresh queries as being permitted for use in determining a query suggestion.

13. The system of claim 12, wherein the current time interval is an interval of time since fresh queries have most recently been identified.

14. The system of claim 12, wherein the current time interval is a predetermined interval of time.

15. The system of claim 12, further comprising instructions to:
calculate individual popularity scores for the fresh queries in the group, wherein an individual popularity score for a given fresh query is based at least in part on a number of times the given fresh query has been submitted during the current time interval; and
use the individual popularity scores for the fresh queries in the group to calculate the group popularity score of the group.

16. The system of claim 15, wherein the instructions to use the individual popularity scores comprises instructions to sum the individual popularity scores to calculate the group popularity score for the group.

17. The system of claim 12, wherein the instructions to use the individual popularity score comprises instructions to use the individual popularity scores for a predetermined number of fresh queries having the highest individual popularity scores to calculate the group popularity score for the group.

18. The system of claim 17, wherein the predetermined number is one.

19. The system of claim 12, wherein the fresh queries in the group have identical canonical representations.

20. The system of claim 12, wherein the canonicalization rules include stemming of terms in the identified fresh queries.

21. The system of claim 12, wherein the canonicalization rules include arranging canonical forms of terms in the identified fresh queries based on a predefined order.

22. The system of claim 12, further comprising instructions to:
receive a query;
select one or more of the permitted fresh queries as query suggestions for the received query; and
send the selected one or more permitted fresh queries in response to receiving the query.

23. A non-transitory computer readable storage medium storing instructions executable by a processor, the instructions including instructions to:
identify a plurality of fresh queries, wherein a fresh query is a query that has been submitted during a current time interval;
reformulate the identified fresh queries into corresponding canonical representations using canonicalization rules;
select a group of fresh queries in the plurality of fresh queries, wherein the fresh queries in the group of fresh queries are selected for inclusion in the group of fresh queries based on determining the fresh queries in the group of fresh queries have matching canonical representations;
calculate a group popularity score for the group of fresh queries, wherein the group popularity score is based at least in part on a number of times that one or more of the fresh queries in the group have been submitted during the current time interval;
determine that the group popularity score for the group satisfies a threshold popularity score; and
in response to the determination, store data identifying the fresh queries in the group of fresh queries as being permitted for use in determining a query suggestion.
